(19) United States
(12) Patent Application Publication
(10) Pub. No.: US 2010/0291282 A1
(43) Pub. Date: Nov. 18, 2010

(54) FLAVORED VODKA AND METHOD OF MAKING THE SAME

(75) Inventor: Miyoko Yamakawa, Garnerville, NY (US)

Correspondence Address: Leason Ellis LLP, 81 Main Street, Suite 503, White Plains, NY, 10601, US

(73) Assignee: Pisces Beverage Corp., Garnerville, NY (US)

(21) Appl. No.: 12/780,020

(22) Filed: May 14, 2010

Related U.S. Application Data
(60) Provisional application No. 61/178,528, filed on May 15, 2009.

(51) Int. Cl. C12G 3/06

(52) U.S. Cl. 426/592

(57) ABSTRACT

A method for preparing a strawberry vodka free of chemical flavoring consists of the steps of: (a) adding vodka to a batch tank and diluting the vodka with purified water until the vodka has an alcohol content between about 60 proof and about 100 proof; (b) adding strawberries to the diluted vodka; (c) incrementally adding crystal sugar to the strawberries over a first prescribed period of time wherein the sugar is added to exposed surfaces of the strawberries so that at least some of the sugar is not initially in contact with the diluted vodka and rests on the strawberries for at least the first prescribed period of time; (d) permitting a second period of time to pass sufficient for a substantial amount of the crystal sugar to melt; (e) removing the strawberries from the vodka leaving behind a strawberry infused vodka; and (f) bottling a quantity of the strawberry infused vodka.

### CROSS-REFERENCE TO RELATED APPLICATION

The present application claims the benefit of U.S. patent application Ser. No. 61/178,528, filed May 15, 2009, which is hereby incorporated by reference in its entirety.

### TECHNICAL FIELD

The present invention relates alcoholic beverages and more particularly, to vodka flavored with a natural ingredient and a method of making the same.

### BACKGROUND

There are a vast number of different alcoholic beverages available and consumed across the globe. Some of the more popular alcoholic beverages are beer, wine and spirits (liquors). As one would assume, within each of these types of beverages, there is a broad selection of choices from a great number of suppliers. For example, there are dark and light beers, red and white wines and different types of spirits, such as rum, gin, whiskey, etc.

Over the recent years, flavored liquors have become increasingly more popular and in particular, one type of liquor that has benefited from this popularity is vodka. A vodka infusion (flavored vodka) is created when vodka is flavored by one or more other ingredients. Technically speaking, the process for flavoring (infusing) the vodka with a flavor is a maceration process in which a flavor is steeped into a fluid. This process is thus also called “infusion.”

Numerous flavors of flavored vodka are commercially available, including lemon, lime as a nonexhaustive list of examples, orange, tangerine, clementine, grapefruit, raspberry, strawberry, blueberry, vanilla, blackcurrant, chili pepper, cherry, apple, cinnamon, coffee, chocolate, peach, pear, passion fruit, pomegranate, mango, banana, pineapple, coconut, mint, melon, and rose.

While these commercial products do offer a flavored vodka experience, they typically suffer from a number of deficiencies. For example, many suppliers use chemicals to add flavor to the vodka as opposed to a true infusion process in which flavor from natural ingredients is infused into the vodka. The use of chemical flavoring reduces the cost of the entire manufacturing process, reduces the process time, and makes it easier to blend due to the absence of natural ingredients. However, a trade off exists in that the taste of flavored vodkas that have been prepared using chemical flavoring is inferior to the taste of infused vodkas that have been prepared using natural ingredients.

Even when natural ingredients are used to infuse the vodka with flavor, there are differences in taste depending upon the precise process that is used to infuse the flavor, as well as choice of ingredients, etc. There is, therefore, a desire to provide an improved process for infusing natural ingredients into vodka to produce a flavored vodka that can be produced on a commercial scale.

### SUMMARY

A method for preparing vodka that is infused with a flavor including the steps of: (a) placing the vodka into a storage container; (b) diluting an initial volume of the vodka with purified water; (c) adding a natural ingredient to the diluted vodka; (d) maintaining the natural ingredient in a position in which the natural ingredient is partially submerged in the diluted vodka but also at the same time includes exposed surfaces; (e) incrementally adding crystal sugar to the natural ingredient over a first prescribed period of time, wherein the sugar is added to at least some of the exposed surfaces so that at least some of the sugar is not in contact with the diluted vodka; (f) waiting a second prescribed period of time for at least substantially all of the sugar to melt, wherein the second period of time is greater than the first period of time; (g) removing the natural ingredient from the vodka leaving behind an infused vodka; and (h) bottling a quantity of the infused vodka.

A method for preparing a strawberry vodka free of chemical flavoring consisting of the steps of: (a) adding vodka to a batch tank and diluting the vodka with purified water until the vodka has an alcohol content between about 60 proof and about 100 proof; (b) adding strawberries to the diluted vodka; (c) incrementally adding crystal sugar to the strawberries over a first prescribed period of time wherein the sugar is added to exposed surfaces of the strawberries so that at least some of the sugar is not initially in contact with the diluted vodka and rests on the strawberries for at least the first prescribed period of time; (d) permitting a second period of time to pass sufficient for a substantial amount of the crystal sugar to melt; (e) removing the strawberries from the vodka leaving behind a strawberry infused vodka; and (f) bottling a quantity of the strawberry infused vodka.

Further aspects and features of the inventive method can be appreciated from the appended Figures and accompanying written description.

### BRIEF DESCRIPTION OF THE DRAWINGS

FIG. 1 is a flow chart of the steps infusing vodka with a natural ingredient in accordance with one embodiment of the present invention;

FIG. 2 is a cross-sectional view of a holding tank used in the infusion process of the present invention showing the natural ingredients in a first location; and

FIG. 3 is a cross-sectional view of a holding tank used in the infusion process of the present invention showing the natural ingredients in a second location.

### DETAILED DESCRIPTION OF PREFERRED EMBODIMENTS

As described herein, the present invention is directed to a vodka flavored product that is infused with flavor from a natural ingredient and to a method of making the same.

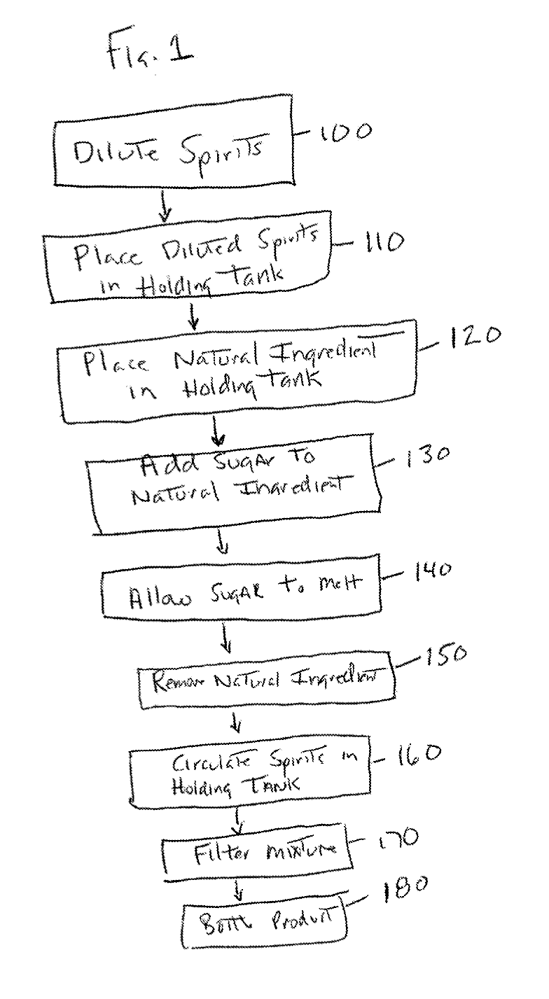

FIG. 1 is a flow chart of the steps for making flavored vodka in accordance with one embodiment of the present invention. In step 100, a predetermined volume of spirits of a predetermined concentration is prepared. In the present invention, the spirits are in the form of neutral grain spirits which are also known as pure grain alcohol or grain neutral spirits. A neutral grain spirit is a clear, colorless, flammable liquid that is distilled from cereal grain and has a very high ethanol content. The term “neutral” refers to the fact that it lacks any flavor derived from the mash used to distill it and, does not have any flavor added to it after distillation. The grain from which it is produced can be any number of common grains that are used to make cereals.

In accordance with the present invention, the spirits are in the form of vodka. As is known, vodka is a distilled beverage that is a clear liquid which consists mostly of water and ethanol purified by distillation from a fermented substance, such as grain, potatoes, etc.

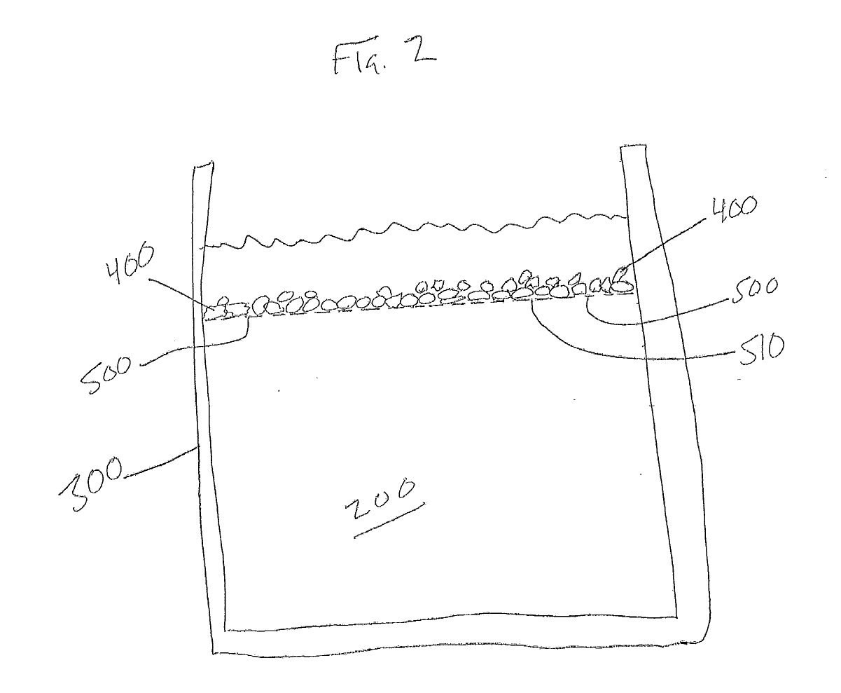

In preparing the proper concentration (proof) of the alcohol, step 100 involves dilution of the grain neutral spirits with water (e.g. purified water). In FIG. 2, the diluted spirits are indicated at 200. The spirits are diluted until they achieve the desired concentration and in particular, until a desired alcoholic proof is obtained. Alcoholic proof is the measure of how much alcohol (ethanol) is contained in the mixture and in the United States, proof is defined as twice the percentage of alcohol by volume. In one embodiment, the spirits are diluted so that they constitute a 60-100 proof alcoholic mixture.

At step 110, a predetermined volume of the diluted spirits 200 is placed into a holding tank 300 shown in FIG. 2. The holding tank 300 can be any number of different types of containers of an appropriate size to hold the diluted spirits 200 as well as other items. For example, the holding tank 300 can be a vat like structure that has a floor 302 and one or more side walls 304. In one embodiment, the holding tank 300 has a cylindrical shape.

After the diluted spirits 200 have been added to the holding tank 300, one or more natural ingredients, shown at 400, are added to the holding tank 300 in step 120. The natural ingredient is the substance from which the flavor diffuses into the spirits.

Any number of different natural ingredients 400 can be used including but not limited to lemon, lime, orange, tangerine, clementine, grapefruit, raspberry, strawberry, blueberry, vanilla, blackcurrant, chili pepper, cherry, apple, cinnamon, coffee, chocolate, ginger root, peach, pear, passion fruit, pomegranate, mango, banana, pineapple, coconut, mint, melon, rose, etc. It will also be appreciated that any number of different types of vegetables can be used in the present process for infusing the vodka with flavor.

Accordingly, two types of natural ingredients 400 that can be added to the diluted spirits 200 are fruits and roots. In one example, the natural ingredient is in the form of fresh strawberries and in another example, the natural ingredient is in the form of ginger roots.

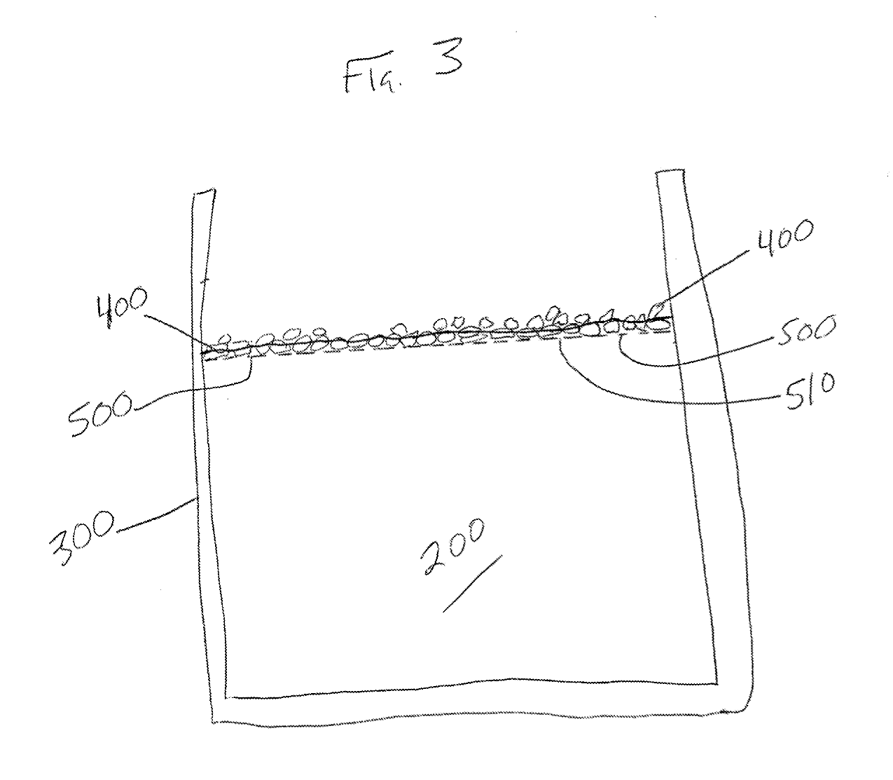

In accordance with the present invention, the location of the natural ingredient 400 in the holding tank 300 is controlled to provide an improved flavored vodka as discussed below. More specifically, the natural ingredients 400 are maintained at or near the top surface of the diluted spirits such that the natural ingredients 400 are at least partially submersed in the diluted spirits 200. FIG. 2 shows one embodiment in which the natural ingredients 400 are totally submerged in the diluted spirits 200, while FIG. 3 shows the natural ingredients 400 only partially submerged.

If the natural ingredients 400 have a density that permits them to float on the top of the diluted spirits 200, then the natural ingredients 400 are placed in the diluted spirits and permitted to float. Typically, enough natural ingredients 400 are placed in the diluted spirits 200 to create a layer across the top surface of the diluted spirits 200. If the natural ingredients 400 have a density that prevents them from floating on the top of the diluted spirits 200, then a support member 500 is provided in the holding tank 300. The support member 500 can be a grate like structure that has a plurality of openings or slots 510 formed therethrough and is constructed and positioned to maintain the natural ingredient preferably at least partially submerged in the vodka but at the same time supporting the natural ingredient so as to have an exposed surface above the vodka. The openings 510 form entrances to the diluted spirits 200 that lies therebelow.

After the natural ingredients 400 are placed in the holding tank 300 and are in contact, at least partially, with the diluted spirits, the next processing step is the addition of sugar to the natural ingredients 400. While there are any number of different types of sugars available, Applicant has discovered that the use of crystal sugar. Crystal sugar (also known as mill white sugar or plantation white) consists of raw sugar where the production process does not remove colored impurities, but rather bleaches them white by exposure to sulfur dioxide. One preferred source of crystal sugar is Japan where it is available as purified crystal sugar.

In accordance with the present invention, at step 130, the crystal sugar is added to the top of the natural ingredients 400. For example, in FIG. 3, the crystal sugar is added to the top exposed surface of the natural ingredients 400 and therefore, some of the sugar will not be exposed immediately to the diluted spirits 200. Any crystal sugar that does pass through the natural ingredients 400 or it otherwise placed into direct contact with the diluted spirits will dissolve into solution. In one embodiment, greater than 50% of the sugar added in any one increment coats the exposed surfaces of the natural ingredient and in another embodiment, greater than 75% of the sugar added in any one increment coats the exposed surfaces of the natural ingredient.

The crystal sugar is added to the natural ingredient during the first week and in particular, it can be added each day of the first week. The amount of crystal sugar that is added to the natural ingredients 400 can vary depending upon the particular processing application and the quantity of the diluted spirits in the holding tank 300. In particular, each day an amount of crystal sugar which relates to a percentage of a total weight of the natural ingredients 400. For example, each day only about 10% of the total weight of the natural ingredients 400 is added until all of the crystal sugar is added. During this process, some of the crystal sugar is typically added on top of crystal sugar that was previously added on top of the natural ingredients 400. Once again, each day some of the added crystal sugar may fall between the natural ingredients 400 or otherwise come into contact with the diluted spirits 200.

In accordance with the present invention, it is preferred for the crystal sugar to remain on the natural ingredients 400 as long as possible before coming into contact with the diluted spirits 200. In effect, this causes a flavor enhancing event to occur since the crystal sugar will be absorbed into the natural ingredients 400 creating sweeter natural ingredients.

At step 140, the crystal sugar is allowed to melt over a period of time. More specifically, a period of time is allowed to pass to allow substantially all of the crystal sugar to melt. This typically occurs about 3 weeks after the first crystal sugar is added to the holding tank 300. In one embodiment, the time period is a time period where about 75% or more of the sugar melts, in about embodiment it is where 85% or more of the sugar melts and in another embodiment, it is a time period where about 90% or more of the sugar melts.

Once again, during this melting process, the crystal sugar can melt over the natural ingredients 400 and run down the natural ingredients 400 into the diluted spirits 200. Some of the crystal sugar will melt on the natural ingredients to sweeten the natural ingredients and since the natural ingredients 400 are in at least partial contract with the diluted spirits 200, the diluted spirits 200 is effectively sweetened. The combination of steps 120 and 130 results in the infusion of flavor into the diluted spirits 200.

At step 150, the natural ingredients 400 are removed from the holding tank 300 after step 140 is completed, thereby leaving only the infused spirits 200 in the holding tank 300.

At step 160, the diluted spirits 200 are circulated within the holding tank 300. The circulation is typically not continuous but rather is a periodic circulation. For example, a pump mechanism (not shown) can be provided and when operated will circulate the infused spirits 200 to circulate. The pump can be operably connected to a controller that has a programmable timer to allow periodic circulation to occur. The infused spirits 200 are circulated for a predetermined period of time and in one embodiment, periodic circulation takes place over about a one week period.

At step 170, the infused spirits 200 are filtered through a suitable filer medium. For example, a strainer or screen having a suitable mesh size can be used. The purpose of the filter medium is to remove any foreign debris or parts of the natural ingredients 400 that may have fallen into or otherwise become mixed with the infused spirits 200. Thus, the mesh size is selected so that the infused spirits can flow uninterrupted therethrough, while any debris is prevented from flowing therethrough and is trapped by the screen, such as a fine screen.

At step 180, the filtered infused spirits are then bottled by transferring and delivering a prescribed amount of the spirits into an individual bottle, container, etc. The delivery can be performed using any number of means, including the use of a pump or the like or can be done manually in small batches.

The present invention thus offers a process for producing improved infused spirits, such as an infused vodka, that avoids the use of chemicals. In particular, the present applicant has discovered that the recited steps and the addition of crystal sugar over time to the natural ingredients for effectively sweetening the natural ingredients as it remains at least partially submerged in the spirits.

It will be appreciated by persons skilled in the art that the present invention is not limited to the embodiments described thus far with reference to the accompanying drawings; rather the present invention is limited only by the following claims.

What is claimed is:

1. A method for preparing vodka that is infused with a flavor comprising the steps of:
placing the vodka into a storage container;
diluting an initial volume of the vodka with purified water;
adding a natural ingredient to the diluted vodka;
maintaining the natural ingredient in a position in which the natural ingredient is partially submerged in the diluted vodka but also at the same time includes exposed surfaces;
incrementally adding crystal sugar to the natural ingredient over a first prescribed period of time, the sugar being added to at least some of the exposed surfaces so that at least some of the sugar is not in contact with the diluted vodka;
waiting a second prescribed period of time for at least substantially all of the sugar to melt, wherein the second period of time is greater than the first period of time;
removing the natural ingredient from the vodka leaving behind an infused vodka; and
filtering and bottling a quantity of the infused vodka.

2. The method of claim 1, wherein the step of diluting the vodka with purified water comprises the step of diluting the vodka so that the diluted vodka is between 60 proof and 100 proof.

3. The method of claim 1, wherein the natural ingredient is selected from the group consisting of lemon, lime, orange, tangerine, clementine, grapefruit, raspberry, strawberry, blueberry, vanilla, blackcurrant, chili pepper, cherry, apple, cinnamon, coffee, chocolate, peach, pear, passion fruit, pomegranate, mango, banana, pineapple, coconut, mint, melon, and rose.

4. The method of claim 1, wherein the step of maintaining the natural ingredient in a position where the natural ingredient is partially submerged in the diluted vodka comprises the step of add natural ingredient that has a density less than a density of the diluted vodka resulting in the natural ingredient floating on a top surface of the diluted vodka.

5. The method of claim 1, wherein the step of maintaining the natural ingredient in a position where the natural ingredient is partially submerged in the diluted vodka comprises the steps of providing a support member within the storage container and placing the natural ingredient on the support member so that the natural ingredient is partially submerged.

6. The method of claim 5, wherein the support member has openings formed therein that communicate with the diluted spirits.

7. The method of claim 5, wherein the natural ingredient that is placed on the support member has a density that is greater than a density of the diluted spirits.

8. The method of claim 5, wherein a top surface of the diluted spirits is above a top surface of the support member resulting in the support member being entirely submerged in the diluted spirits.

9. The method of claim 1, wherein the first prescribed period of time comprises about 1 week and the second prescribed period of time comprises about 3 weeks.

10. The method of claim 1, wherein greater than 50% of the sugar added in any one increment coats the exposed surfaces of the natural ingredient.

11. The method of claim 1, wherein greater than 75% of the sugar added in any one increment coats the exposed surfaces of the natural ingredient.

12. The method of claim 1, wherein the step of incrementally adding crystal sugar to the natural ingredients over a first prescribed period of time comprises the step of adding about 10% of a total weight of the natural ingredient in sugar each day until all of the sugar is added.

13. A method for preparing a strawberry vodka free of chemical flavoring consisting of the steps of:
adding vodka to a batch tank and diluting the vodka with purified water until the vodka has an alcohol content between about 60 proof and about 100 proof;
adding strawberries to the diluted vodka;
incrementally adding crystal sugar to the strawberries over a first prescribed period of time, the sugar being added to exposed surfaces of the strawberries so that at least some of the sugar is not initially in contact with the diluted vodka and rests on the strawberries for at least the first prescribed period of time;
permitting a second period of time to pass sufficient for a substantial amount of the crystal sugar to melt;
removing the strawberries from the vodka leaving behind a strawberry infused vodka; and
filtering and bottling a quantity of the strawberry infused vodka.

14. The method of claim 13, further including the step of maintaining the strawberries in a position where the strawberries are partially submerged in the diluted vodka.

15. The method of claim 14, wherein the step of maintaining the strawberries in a position where the strawberries are partially submerged in the diluted vodka comprises the steps of providing a support member within the tank and placing the strawberries on the support member so that the strawberries are partially submerged, the support member having openings formed therein to allow melted sugar to come into contact with the vodka and to allow the vodka to flow therethrough into contact with the strawberries.

16. The method of claim 14, wherein the second period of time is a time period in which at least 90% of the sugar melts.

17. A vodka prepared in accordance with the method of claim 1.
